(19) United States
(12) Patent Application Publication
(10) Pub. No.: US 2004/0190086 A1
(43) Pub. Date: Sep. 30, 2004

(54) Multi-function peripheral

(75) Inventors: Ming-Yuh Yeh, Taipei (TW); Jyh-Kwang Chen, TaiNan (TW); Hui-Huang Chang, Hsinchu (TW)

Correspondence Address: BRUCE H. TROXELL, SUITE 1404, 5205 LEESBURG PIKE, FALLS CHURCH, VA, 22041, US

(73) Assignee: Realtek Semiconductor Corp.

(21) Appl. No.: 10/805,330

(22) Filed: Mar. 22, 2004

(30) Foreign Application Priority Data
Mar. 28, 2003 (TW) 92204825

(51) Int. Cl. G06F 15/00; H04N 1/04

(52) U.S. Cl. 358/479; 358/1.15

(57) ABSTRACT

A multi-function peripheral (MFP) includes a built-in video encoder. Through the video encoder, an image data can be directly displayed on the large-size screen of a TV or computer monitor, and an user can then preview, select and process the image data thereon. The MFP may also include one or more I/O interfaces used to connect other commercially available electronic devices.

### BACKGROUND OF THE INVENTION

(a). Field of the Invention

The present invention relates to a multi-function peripheral (MFP), and more particularly to a MFP equipped with an input/output interface used to connect other commercially available electronic devices.

(b). Description of the Related Arts

Nowadays, image-processing devices, such as photocopying machines, fax machines, printers, scanners, etc., become necessary and popular in modern offices, and functions of these image-processing devices also become increasingly complex and advanced.

The multi-function peripheral (MFP) is a newly developed image-processing device in recent years. The MFP can process image data without connecting to a computer. FIG. 1 shows a block diagram of a conventional MFP 1. The MFP 1 includes an image-scanning module 11, a step motor 12, a printing module 13, a controller 14, and a push button 15. The MFP 1 combines together multiple functions of scanning, printing, faxing and copying, and the cost of the MFP 1 is generally lower than the total cost of using an individual device for each of the functions mentioned above.

The conventional MFP 1 has no display function for displaying image data. Thus, a user cannot preview the image data to determine a proper processing thereon, such as enlarging, shrinking, brightness adjusting, etc., unless the user makes a paper print-out of the image data. Thus, there would be a waste of paper and ink. Making the paper print-out for previewing is also time-consuming. Other conventional MFPs may have a small-size LCD monitor to allow the user to preview the image data. However, the image data cannot be shown clearly enough on the small-size LCD monitor and most of the image-processing tasks cannot be properly executed.

In addition, the MFP 1 has the push button 15 or a touch panel for issuing a command to operate the MFP 1. In consideration of the machine size, the number of push buttons is usually needed to be few and the size of the touch panel to be small. Accordingly, it is rather difficult to carry out the complicated functions of the MFP with only the few push buttons. To yield to the limited buttons, complex input combinations may be designed for full operation of the MFP. This would be very unfriendly for users to remember and employ the complex input combinations.

### SUMMARY OF THE INVENTION

It is one of the many objectives of the present invention to provide a MFP capable of being connected to other commercially available electronic devices, such a TV, a computer monitor, a keyboard or a mouse, thereby facilitating operation of the MFP. Thereby users can preview a large-size image data on the TV or the computer monitor, and/or operate the MFP by the keyboard and/or the mouse.

According to embodiments of the present invention, a multi-function peripheral (MFP) is disclosed. The MFP comprises a functional block for executing a function of the MFP; a controller coupled to the functional block, for controlling the operation of the functional block; a video encoder, coupled to the controller, for encoding an image data to an encoded data with a video format; and a video output interface, coupled to the video encoder and a display unit, for transferring the encoded data to the display unit. The display unit corresponds with the video format.

According to embodiments of the present invention, another multi-function peripheral (MFP) is also disclosed. The MFP comprises a functional block for executing a function of the MFP; a controller coupled to the functional block, for controlling the operation of the functional block; and an input interface coupled to the controller, for connecting to an external input unit. A commend followed by the controller is issued from the external input unit.

These and other objectives of the present invention will no doubt become obvious to those of ordinary skill in the art after reading the following detailed description of the embodiments that is illustrated in the various figures and drawings.

### BRIEF DESCRIPTION OF THE DRAWINGS

FIG. 1 is a block diagram of a conventional MFP.

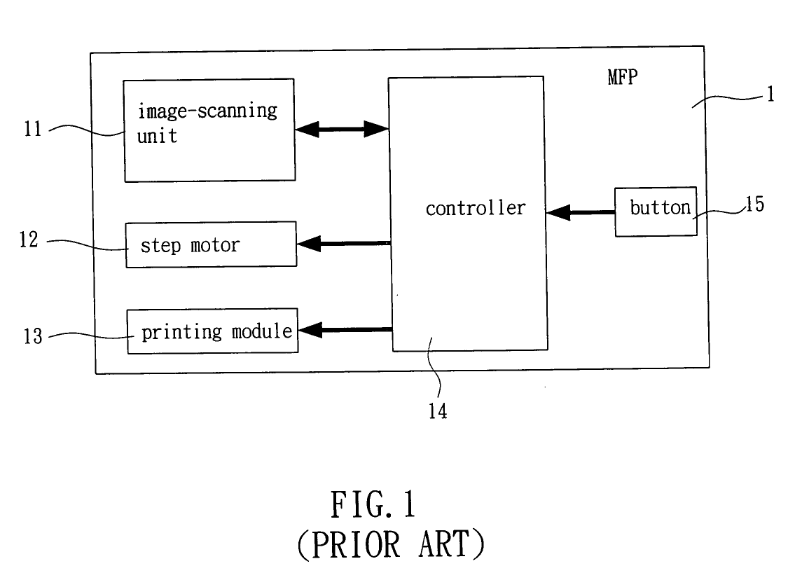

FIG. 2 is a block diagram showing a MFP according to a first embodiment of the present invention.

FIG. 3 is a block diagram showing a MFP according to a second embodiment of the present invention.

### DETAILED DESCRIPTION OF THE EMBODIMENTS

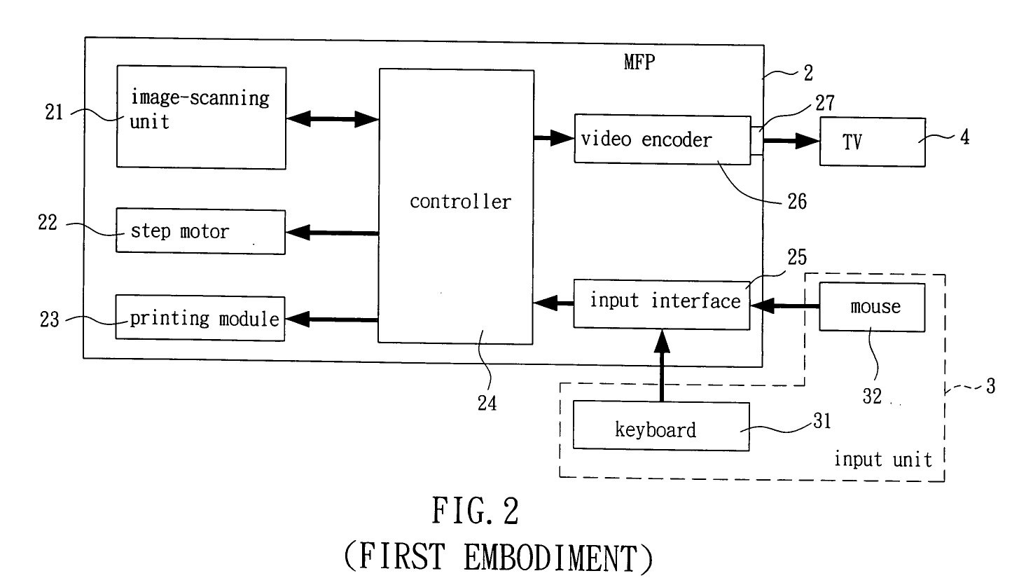

FIG. 2 shows a multi-function peripheral (MFP) 2 according to a first embodiment of the present invention. The MFP 2 contains an image-scanning module 21, a controller 24, a video encoder 26, a step motor 22, a printing module 23, and a video output interface 27. The image-scanning module 21 scans an original image by an image sensor installed therein and outputs a corresponding image data. The image sensor can be a CCD, CMOS sensor, or the like. which can convert an image into electronic signals. The step motor 22 is for controlling the paper feeding operations. The printing module 23 is for printing image data onto paper. The controller 24 is for controlling parts and circuits within the MFP 2. The video encoder 26, coupled to the controller 24, is for encoding image data into encoded image data with a proper video format, and outputting the encoded image data to an external display unit via the video output interface 27. In the embodiment, the video output interface 27 can be a wire interface or a wireless communication interface. For example, the video output interface 27 is a TV out or a RGB video output interface or a bluetooth interface or a Radio Frequency (RF) interface.

In the first embodiment, the video output interface 27 of the MFP 2 is connected to a TV 4 in order to display the encoded image data thereon. The TV 4 can be a commercially available CRT TV, LCD TV, Plasma TV, digital TV, or the like. The video output interface 27 corresponds to the type of the TV 4. For example, if the TV 4 is a CRT TV, a TV out is used as the video output interface 27. In addition, as mentioned above, the video encoder 26 of the MFP 2 can transform image data into encoded image data with a proper video format. Here the video format is selected according to the type of TV 4. For example, if the TV 4 is a CRT TV, then a NTSC or PAL format is selected as the video format of the encoded image data. Under other circumstances, the video format can also be a VGA format. Thus, when a user wants to process the image data, the user can preview it through a large-size screen of the TV 4 rather than through a paper print-out. Thus, the cost of paper and ink can be saved. Moreover, since the TV 4 in the first embodiment of FIG. 2 is a commercially available TV which is common in most families, the user needs not to purchase any additional display devices.

The MFP 2 of the first embodiment further includes an input interface 25 which can be coupled to a command input unit 3 for controlling the operation of the MFP 2. In this embodiment, the input unit 3 may include a keyboard 31 or a mouse 32, and the input interface 25 can be, without limitation, a USB, PS2, RS232 or infrared interface. A user can control the MFP 2 through the mouse 32 or the keyboard 31. Because the keyboard 31 contains many buttons, a complex function combination of the MFPs can therefore be fully supported. The mouse 32 also provides a more flexible-in-operation choice other than push buttons to the MFPs.

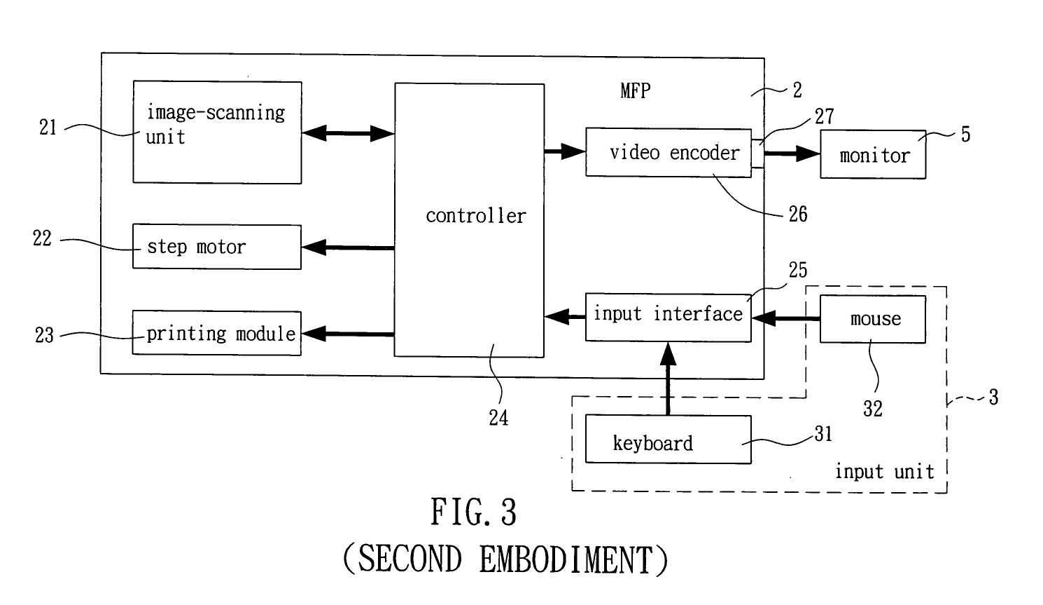

FIG. 3 shows a second embodiment of the present invention. Compared to the first embodiment of FIG. 2, the MFP 2 in the second embodiment of FIG. 3 is coupled to a monitor 5, which can be a CRT monitor or a LCD monitor. The video encoder 26 encodes the image data into an encoded image data with a VGA format. The operation and benefit of the second embodiment are similar to those described in the first embodiment.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A multi-function peripheral (MFP) comprising:
a functional block for executing a function of the MFP;
a controller coupled to the functional block, for controlling the operation of the functional block;
a video encoder, coupled to the controller, for encoding an image data to an encoded data with a video format; and
a video output interface, coupled to the video encoder and a display unit, for transferring the encoded data to the display unit;
wherein the display unit corresponds with the video format.

2. The MFP of claim 1, wherein the video output interface is a wireless communication interface.

3. The MFP of claim 1, wherein the video output interface is a wire interface.

4. The MFP of claim 1, wherein the video format is a NTSC format.

5. The MFP of claim 1, wherein the video format is a PAL format.

6. The MFP of claim 1, wherein the video format is a VGA format.

7. The MFP of claim 1, wherein the display unit is a television and the video output interface is a TV-OUT.

8. The MFP of claim 1, further comprising:
an input interface, coupled to an input unit, for receiving a command from the input unit;
wherein the MFP is controlled according to the command.

9. The MFP of claim 8, wherein the input unit is a mouse.

10. The MFP of claim 8, wherein the input unit is a keyboard.

11. The MFP of claim 8, wherein the input interface is a USB interface.

12. A multi-function peripheral (MFP) comprising:
a functional block for executing a function of the MFP;
a controller coupled to the functional block, for controlling the operation of the functional block; and
an input interface coupled to the controller, for connecting to an input unit;
wherein a commend followed by the controller is issued from the input unit.

13. The MFP of claim 12 further comprising:
a video encoder, coupled to the controller, for encoding an image data to an encoded data with a video format; and
a video output interface, coupled to the video encoder and a display unit, for transferring the encoded data to the display unit;
wherein the display unit corresponds with the video format.

14. The MFP of claim 12, wherein the functional block is an image-scanning module.

15. The MFP of claim 12, wherein the functional block is a printing module.

16. The MFP of claim 12, wherein the input unit is a keyboard.

17. The MFP of claim 12, wherein the input unit is a mouse.

18. A printing apparatus comprising:
a functional block for executing a printing function;
a controller coupled to the functional block, for controlling the operation of the functional block;
a video encoder, coupled to the controller, for encoding an image data to an encoded data with a video format; and
a video output interface, coupled to the video encoder and a display unit, for transferring the encoded data to the display unit;
wherein the display unit corresponds with the video format.

19. The printer of claim 18, wherein the video output interface is a wireless communication interface.

20. The printer of claim 18, wherein the video output interface is a wire interface.
